(19) United States
(12) Patent Application Publication
(10) Pub. No.: US 2017/0024745 A1
(43) Pub. Date: Jan. 26, 2017

(54) NETWORK MANAGEMENT EVENT ESCALATION

(71) Applicant: INTERNATIONAL BUSINESS MACHINES CORPORATION, Armonk, NY (US)

(72) Inventors: Anthony T. Brew, Cork (IE); Paul B. French, Cork (IE); John Russell, Cork (IE); Jonathan I. Settle, London (GB); Kristian J. Stewart, London (GB)

(21) Appl. No.: 14/803,584

(22) Filed: Jul. 20, 2015

(51) Int. Cl. G06Q 30/00

(52) U.S. Cl. CPC G06Q 30/016

(57) ABSTRACT

A network management system includes an index of historical events, some of which are associated with at least one historical group type and including for the at least one historical group type, the probability that an historical group of that type will lead to a further event action. Further, the network management system includes for each historical event type, the probability that an historical event of that type will be in the at least one historical group; an event classifier for determining, from the index, an historical group type associated with a new event; an action probability classifier for determining the probability of a further event action occurring due to the new event based on the probability of the associated historical group leading to an historical further event action and the probability of the new event being in the associated historical group; and an event tagger for assigning the probability of the further event action to the new event.

### BACKGROUND

One or more aspects of the present invention relate to network management event escalation.

Data center and network management disciplines are focused extensively on fault root cause analysis, tools and best practices. When an event occurs in a data center, a simple network management protocol notification or other type of notification is sent to an event manager. The event may be deduplicated, correlated, enriched and may be handled via a policy enforced by a rules engine. The event may be used to automatically create a ticket for a help desk. Events and tickets are the backbone of fault management. For providers of large telecommunication networks, in particular, the scale in relation to the number of events has increased rapidly. This is a consequence of the growth in customer numbers, an increased average level of usage per customer and consolidation through mergers to form larger telecommunication companies. There is also increased diversity of events due to an expanding variety of devices that are monitored as new technologies are adopted. Finally, these organizations are facing significant revenue challenges as the average revenue per user is declining in many geographies. A network management system that reduces the number of events worked by operators or the number of tickets generated without affecting the performance and availability of services in the data center would be used to: reduce cost; reduce mean time to repair; and increase rate of return in investment.

An event can be prioritized through manual rules such as what part of the infrastructure it affects and over time a convergence can occur that ends with every event being “high priority”. Some actions truly mark an event as having a higher priority, but many are “after the fact”, that is, when it is only abundantly obvious that the event is “high priority”.

For example, an event that becomes manually ticketed, indicates an escalation of the severity of the ticket. It shows that the current support team was unable to process the event and that the event needs to be escalated to a ticketed event to be resolved.

After a flurry of events leads up to a ticket, it is a manual process to assign the ticket to all the events that are related. Evidence from customer datasets have shown that some events that were part of the ticketed issue were not directly associated with the ticket.

### SUMMARY

In one aspect, a method is provided that includes, for instance, receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group; receiving a new event; determining, from the index, an historical group type associated with the new event; determining a probability of a further event action occurring due to the new event based on a probability of an associated historical group leading to an historical further event action and a probability of the new event being in the associated historical group; and assigning, to the new event, the probability of the further event action occurring due to the new event.

In a further aspect, a computer program product is provided. The computer program product includes, for instance, a computer readable storage medium readable by a processing circuit and storing instructions for execution by the processing circuit for performing a method. The method includes, for instance, receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group; receiving a new event; determining, from the index, an historical group type associated with the new event; determining a probability of a further event action occurring due to the new event based on a probability of an associated historical group leading to an historical further event action and a probability of the new event being in the associated historical group; and assigning, to the new event, the probability of the further event action occurring due to the new event.

In yet another aspect, a network management system is provided. The network management system includes, for instance, a memory; and a processor in communications with the memory, wherein the network management system is configured to perform a method. The method includes, for instance, receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group; receiving a new event; determining, from the index, an historical group type associated with the new event; determining a probability of a further event action occurring due to the new event based on a probability of an associated historical group leading to an historical further event action and a probability of the new event being in the associated historical group; and assigning, to the new event, the probability of the further event action occurring due to the new event.

### BRIEF DESCRIPTION OF THE DRAWINGS

Embodiments of the present invention will now be described, by way of example only, with reference to the following drawings in which:

FIG. 1 is a deployment diagram of one embodiment;

FIG. 2 is a component diagram of one embodiment;

FIG. 3A is a flow diagram of an historical event method of one embodiment;

FIG. 3B is a flow diagram of a new event method of one embodiment;

FIG. 3C is a flow diagram of a new event method of an alternate embodiment;

FIGS. 4A and 4B are flow diagrams of two different embodiments for assigning a priority to an event;

FIG. 5 is an example of an historical group of events;

FIGS. 6A, 6B, and 6C are a series of three state diagrams showing new events as they are received and are treated as individual events in one embodiment; and

FIGS. 7A, 7B, and 7C are a series of three state diagrams showing new events as they are received and associated with a speculative group.

### DETAILED DESCRIPTION

A network management system collects enterprise-wide event information from multiple network data sources and presents a simplified view of this information to end users. The network management system manages the event information for: assignment to operators; passing on to helpdesk systems based on a database; logging in a database such as a helpdesk customer relationship management system (CRM); replicating on a remote service level management system; and triggering automatic responses to certain alerts. A network management system also consolidates information from different domain limited network management platforms in remote locations. By working in conjunction with existing management systems and applications, the network management system minimizes deployment time and enables employees to use their existing network management skills.

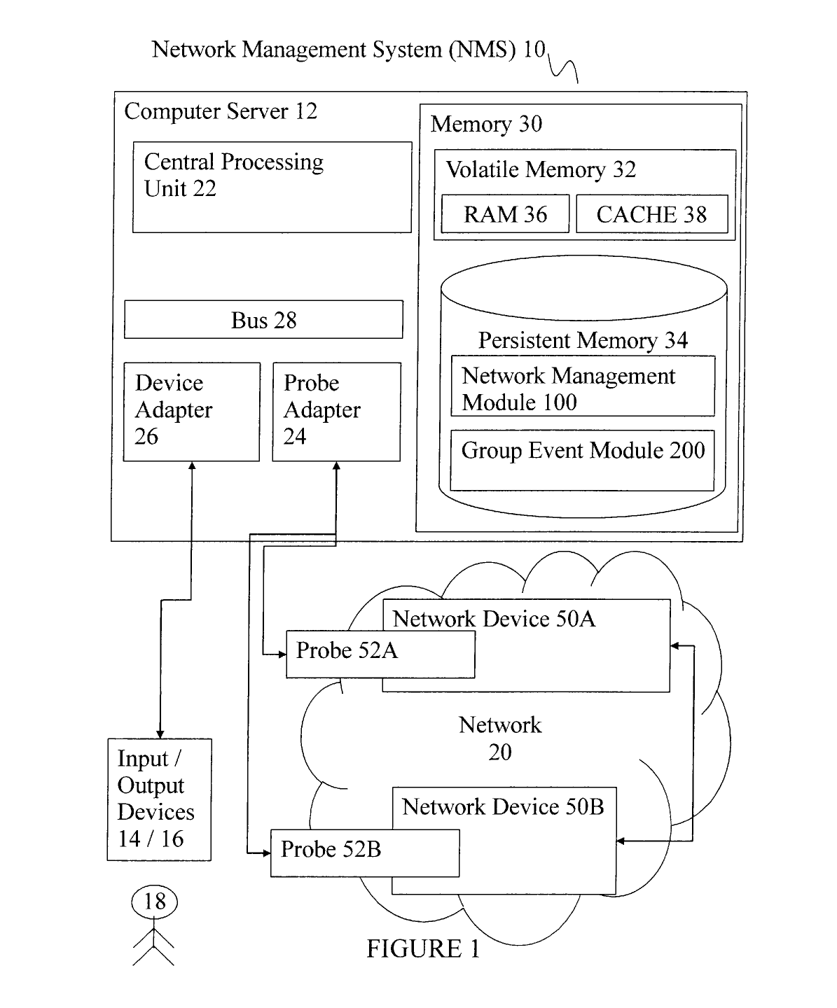

Referring to FIG. 1, the deployment of one embodiment in a network management system 10 is described. Network management system 10 is operational with numerous other general purpose or special purpose computing system environments or configurations. Examples of well-known computing processing systems, environments, and/or configurations that may be suitable for use with network management system 10 include, but are not limited to, personal computer systems, server computer systems, thin clients, thick clients, multiprocessor systems, microprocessor-based systems, network PCs, minicomputer systems, mainframe computer systems, and distributed computing environments that include any of the above systems or devices. A distributed computer environment includes a cloud computing environment for example where a network management system is a third party service performed by one or more of a plurality of network management systems.

Network management system 10 may be described in the general context of computer system-executable instructions, such as program modules, being executed by a computer processor. Generally, program modules may include routines, programs, objects, components, logic, and data structures that perform particular tasks or implement particular abstract data types. Network management system 10 may be embodied in distributed cloud computing environments where tasks are performed by remote processing devices that are linked through a communications network. In a distributed cloud computing environment, program modules may be located in both local and remote computer system storage media including memory storage devices.

Network management system 10 includes, for instance: a general-purpose computer server 12 and one or more input devices 14 and output devices 16 directly attached to the computer server 12. Network management system 10 is connected to an example network 20 via probes 52A and 52B respectively. Network 20 includes network devices 50A and 50B. Network management system 10 communicates with a user 18 using input devices 14 and output devices 16. Input devices 14 include one or more of: a keyboard, a scanner, a mouse, trackball or another pointing device. Output devices 16 include one or more of a display or a printer. Network 20 can be a local area network (LAN), a wide area network (WAN), or the Internet. Two networked devices are shown in this example, but any number of networked devices can feed a network event.

Computer server 12 includes, for instance, a central processing unit (CPU) 22; a network adapter 24; a device adapter 26; a bus 28 and memory 30.

CPU 22 loads machine instructions from memory 30 and performs machine operations in response to the instructions. Such machine operations include, for instance: incrementing or decrementing a value in a register; transferring a value from memory 30 to a register or vice versa; branching to a different location in memory if a condition is true or false (also known as a conditional branch instruction); and adding or subtracting the values in two different registers and loading the result in another register. A typical CPU can perform many different machine operations. A set of machine instructions is called a machine code program. The machine instructions are written in a machine code language which is referred to as a low level language. A computer program written in a high level language may be compiled to a machine code program before it is run. Alternatively, a machine code program, such as a virtual machine or an interpreter, can interpret a high level language in terms of machine operations.

Probe adapter 24 is connected to bus 28 and network 20 for enabling communication between the computer server 12 and the probes.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Examples of persistent memory 34 are read only memory (ROM) and erasable programmable read only memory (EPROM). Generally, volatile memory is used because it is faster, and generally, non-volatile memory is used because it will hold the data for longer. Network management system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk, such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The set of program modules configured to carry out the functions of one embodiment includes, for instance, a network management module 100 and a group event module 200. In one embodiment, ROM in memory 30 stores network management module 100 that enables the computer server 12 to function as a network management system 10. Further, program modules that support one embodiment but are not shown include firmware, a boot strap program, an operating system, and support applications. Each of the operating system, support applications, other program modules, and program data or some combination thereof, may include an implementation of a networking environment.

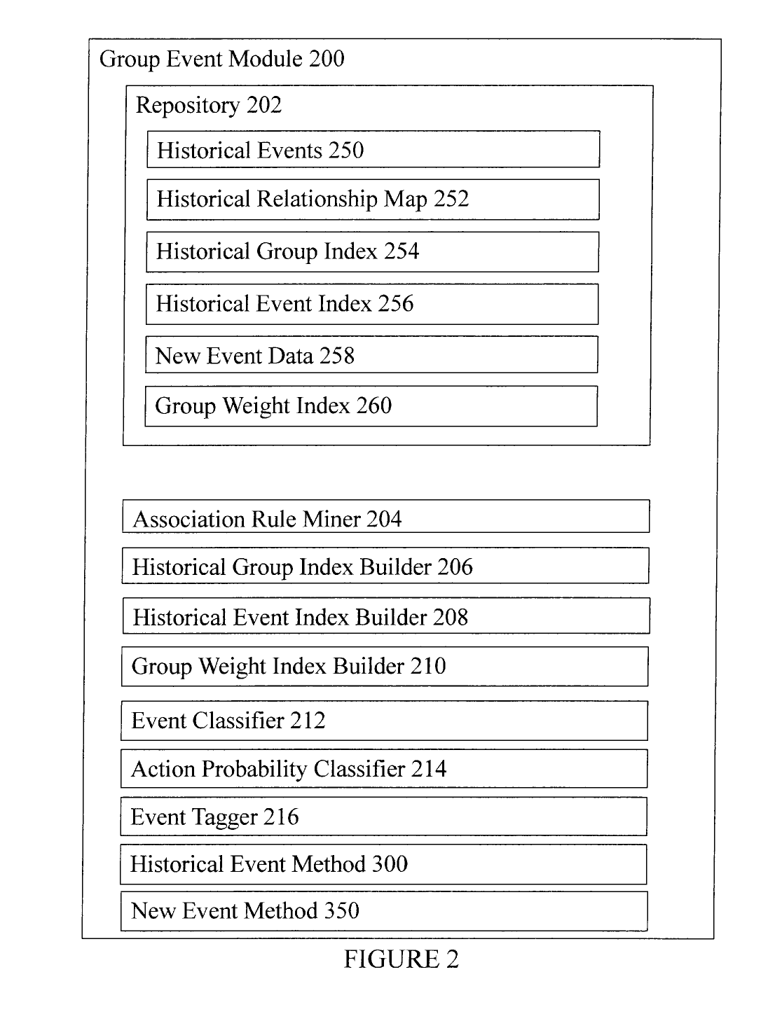

Referring to FIG. 2, group event module 200 includes, for instance, the following components: a repository 202; an association rule miner 204; an historical group index builder 206; an historical event index builder 208; a group weight index builder 210; an event classifier 212; an action probability classifier 214; an event tagger 216; an historical event method 300; and a new event method 350.

Over time, as events enter the system, information pertaining to individual event keys or serial identifiers are collected. Examples abound such as: the number of occurrences of an event; time since the first occurrence; a particular affected node in the system; and if an event has been escalated. Eventually, a further event action (also known as a ticket or action trigger) may occur. This may be humanly observed, or physically invoked either humanly or automatically. Examples of such further event actions are, e.g., the event is ticketed; the event is escalated; and/or the event takes a longer than normal time to acknowledge. Each of these further event actions divide historic events into two distinct classes: those that lead to an aforementioned further event action; and those that do not.

Repository 202 includes storage for, e.g., historical events 250; a historical relationship map 252; a historical group index 254; an historical event index 256; new event data 258; and a group weight index 260.

Historical events 250 comprise a super set of events including further event actions, such as when an event has been tagged by an administrator.

Historical relationship map 252 is a map formed by the association rule miner 204 showing groups of events that are associated with the same further event action. A map is a related network of events built from a history of events received. In one embodiment, an historical relationship map is formed from events that have entered the system based on a variation of association rule mining to find common statistically recurring event paths.

Historical Group Index 254 is an index of historical group types including, for each historical group type and associated further event action, the probability that a group of events of that type will lead to a further event action.

Historical Event Index 256 is an index of historical event types including, for each historical event type, the probability that a event of that type will be in at least one historical group.

New event data 258 is a data structure for storing new events.

Group Weight Index 260 is an index of further event action types by priority.

Association rule miner 204 is for mining historical events and further event actions to identify an historical group type from related historical events that can lead to a further event action. Association rule miner 204 is also for identifying a further event action probability for a group of new events of the historical group type. The association rule miner 204 is also for modeling the probability that an historical event in an historical group is responsible for a further action event and for estimating the probability that a new event will be responsible for a further action. In one embodiment, a simple binary classifier such as naive Bayes may be used to classify and determine the probabilities. In more complex embodiments, logistic regression or support vector machines are used to classify and determine the probabilities.

Historical group index builder 206 is for creating an index of historical group types and respective probabilities of leading to further event actions.

Historical event index builder 208 is for creating an index of historical event types and respective probabilities of being in an historical group type.

Group weight index builder 210 is for creating an index of further event actions and weight of importance.

Event classifier 212 is for determining, from the index, an historical group type associated with a new event.

Action probability classifier 214 is for determining the probability of a further event action occurring due to the new event based on the probability of the associated historical group leading to an historical further event action and the probability of the new event being in the associated historical group.

Event tagger 216 is for assigning the probability of the further event action to the new event.

In an alternative embodiment, a speculative relationship map is part of the group event module 200 for speculatively associating one or more groups of new events with one more new historical groups.

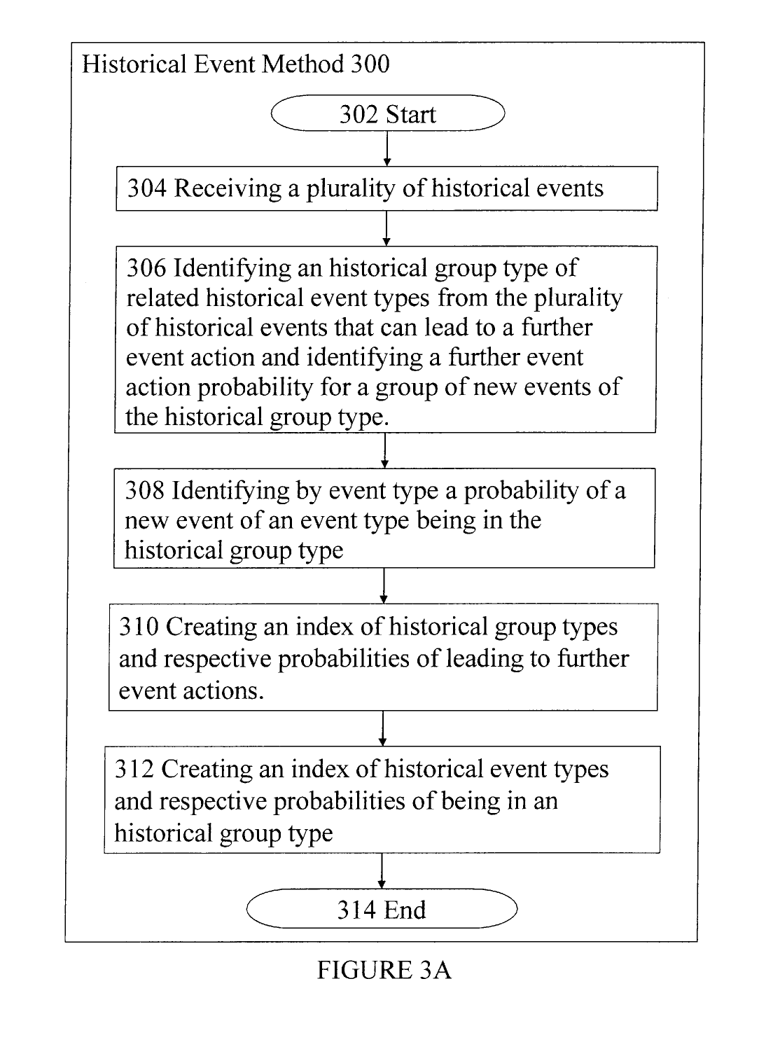

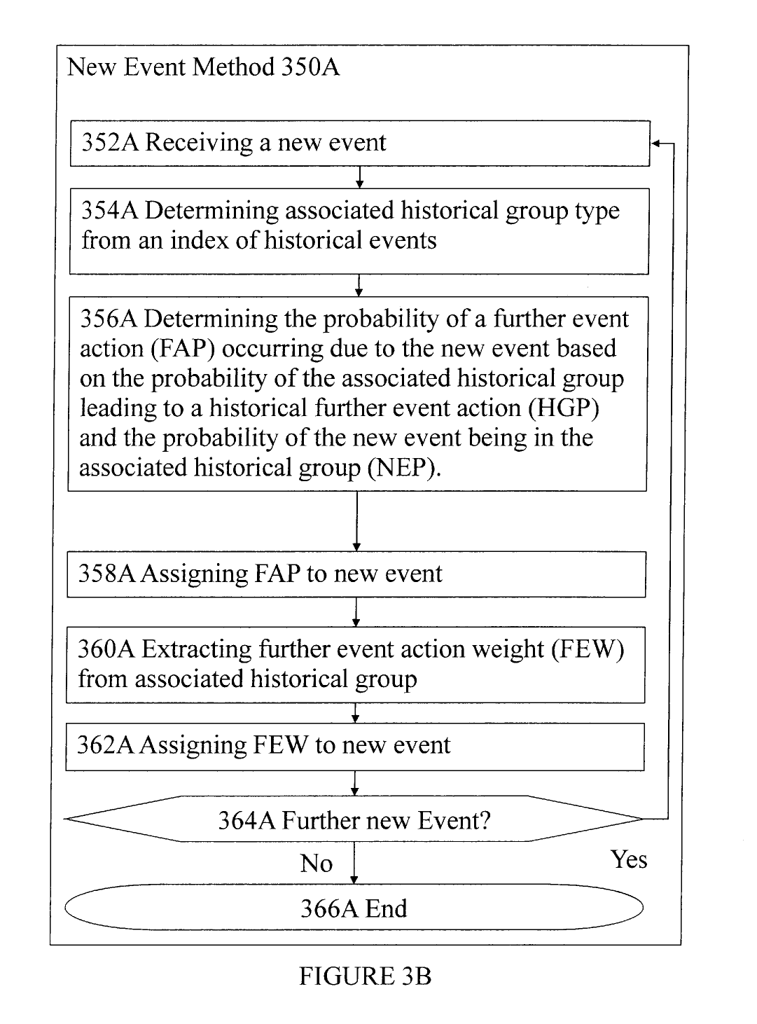

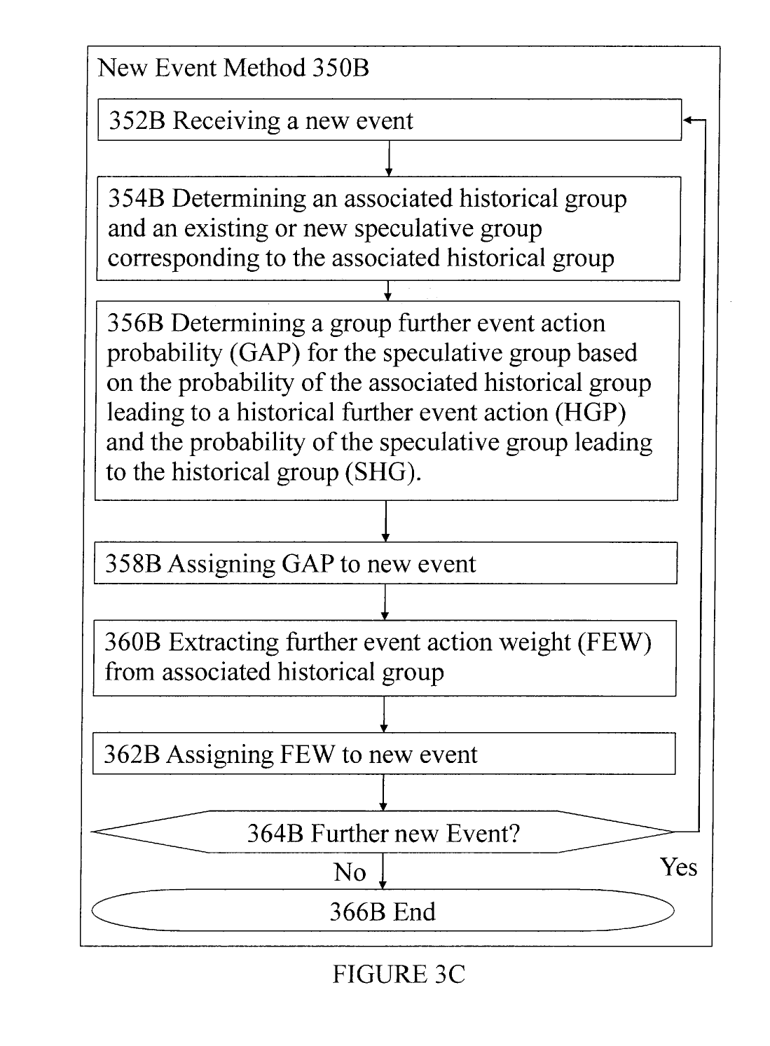

Historical event method 300 is for identifying an historical group or groups of related events within a plurality of historical events and is described below in relation to FIG. 3A.

New event method 350 is for performing method 350A of one embodiment (described later with reference to FIG. 3B) or method 350B of an alternative embodiment (described below with reference to FIG. 3C).

Referring to FIG. 3A, one embodiment of historical event method 300 comprises logical process steps 302 to 314. Although there is an order to the embodiment steps as described, the steps may not necessarily need to be in this order. In other embodiments, the steps may be in a different order.

Step 302 is the start of the group event method as initiated in response to a user command or a system event.

Step 304 is for receiving a plurality of historical events.

Step 306 is for identifying an historical group type of related historical event types from the plurality of historical events that can lead to a further event action and identifying a further event action probability for a group of new events of the historical group type. Groups of co-related events may be found by one of several mechanisms used individually or in combination. For instance, by mining or clustering the time ordered event stream for commonly recurring patterns using methods that are commonly referred to as sequential pattern mining techniques. As another example, by mining from the time ordered event stream groups of clustered events where the clustering has been modified to use time as a contributory factor (for example clustering or principle components analysis). In yet a further example, explicitly reading a known topology provided directly to the algorithm for reference, for example architectural topology for the application infra-structure; or by discovered topology via automated scanning of a network. The probability can be any probability but for pragmatic reasons is taken to be above an arbitrary threshold value that matches the resources available. For instance, groups having a probability of over a 50% chance of leading to a further event action would be reasonable.

Step 308 is for identifying by event type a probability of a new event of that type being in the historical group type.

Step 310 is for creating an index of historical group types and respective probabilities of leading to further event actions.

Step 312 is for creating an index of historical event types and respective probabilities of being in an historical group.

Step 314 is the end of historical event method 300.

Referring to FIG. 3B, one embodiment of new event method 350A comprises logical process steps 352A to 366A. Although there is an order to the embodiment steps as described, the steps do not necessarily need to be in this order unless specified. In other embodiments, the steps can be in a different order.

Step 352A is for receiving a new event.

Step 354A is for determining an associated historical group type from the index by finding the most probable historical group type for the new event.

Step 356A is for determining the probability of a further event action being associated with the new event (Further Action Probability (FAP)) based on the probability of the associated historical group leading to an historical further event action (Historical Group Probability (HGP)) and the probability of the new event being in the associated historical group (New Event Probability (NEP)). One embodiment multiplies the probability of the associated historical group leading to an historical further event action (HGP) with the probability of the new event being in the associated historical group (NEP).

Step 358A is for assigning a further event action probability (FAP) to the new event.

Step 360A is for extracting a further event action weight (FEW) from an associated historical group.

Step 362A is for assigning the further event action weight (FEW) to the new event.

Step 364A is for branching back to step 352A, if there is a further new event. Otherwise, to step 366A.

Step 366A is the end of the new event method 350A.

Referring to FIG. 3C, an alternative embodiment of new event method 350B comprises logical process steps 352B to 366B. Although there is an order to the embodiment steps as described, the steps may not necessarily need to be in this order. In other embodiments, the steps can be in a different order. This embodiment introduces the concept of speculative groups. A speculative group is a group of new events that are speculated to turn out to be an historical group, which in turn may lead to a further event action. It is speculated that a speculative group (for example HG1.1 is a speculative group of historical group HG1) will eventually comprise the same event types as its historical group and the probability of this increases with each new event associated with the speculative group.

Step 352B is for receiving a new event.

Step 354B is for determining an associated historical group and an existing or new speculative group corresponding to the associated historical group. The new event and existing speculative groups are compared to the historical groups and the combined comparisons with the highest similarities are carried forward as new speculative groups. A new event will additionally form its own speculative group if there is an historical group that contains that new event.

Step 356B is for determining a group further event action probability (GAP) for the speculative group based on the probability of the associated historical group leading to an historical further event action (HGP) and the probability of the speculative group leading to the historical group (SHG). An alternative embodiment multiplies the probability of the associated historical group leading to a historical further event action (HGP) with the proportion of the speculative group that is already of the associated historical group type (for example one of three event types is 33%, two of three event types is 66% and all event types is 100%.). Another embodiment might determine a more precise probability based on the similarity of the speculative group to the historical group and the proportion of historical events to the events in the speculative group.

Step 358B is for assigning the group event probability (GAP) to the new event.

Step 360B is for extracting a further event action weight (FEW) from an associated historical group.

Step 362B is for assigning the further event weight (FEW) to the new event.

Step 364B is for branching back to step 352B if there is a further new event. Otherwise, to step 366B.

Step 366B is the end of the new event method 350B.

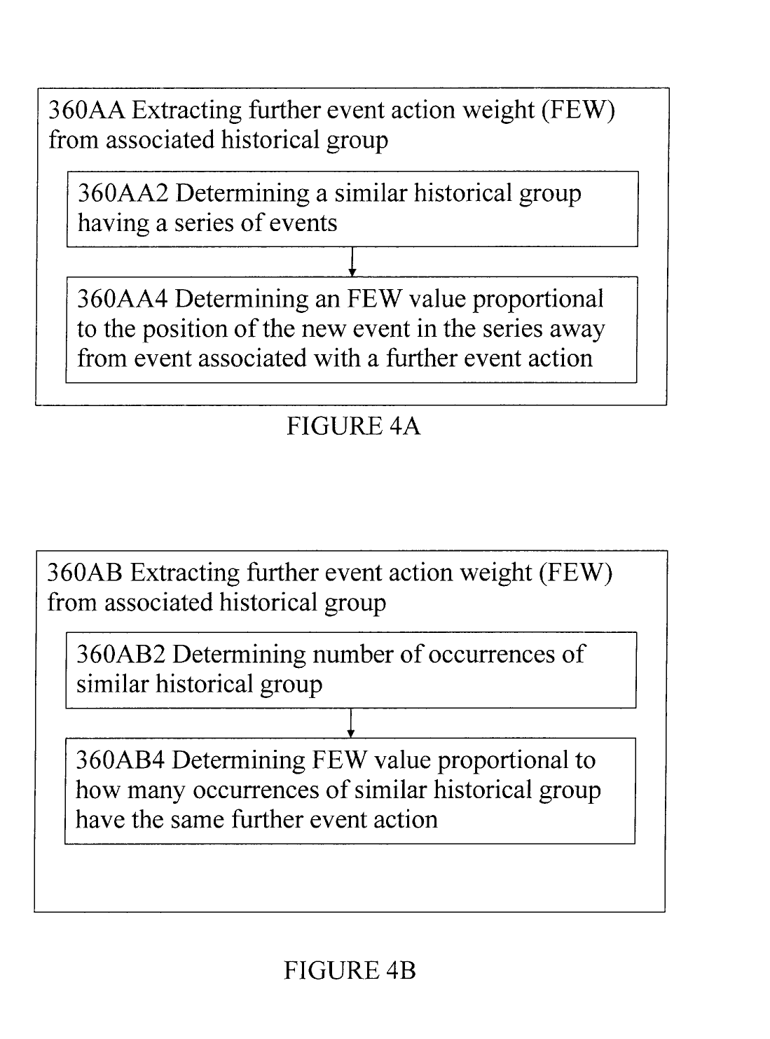

Referring to FIG. 4A, in one embodiment, step 360A comprises step 360AA. Step 360AA comprises logical process steps 360AA2 and 360AA4.

Step 360AA2 is for determining a similar historical group including a series of events.

Step 360AA4 is determining a FEW value proportional to the position of the new event in the series away from an event associated with a further event action.

The FEW value is determined as follows, in one example: instead of every event in the group receiving a FEW of one (for example), each event receives a FEW between zero and one depending on how close the event is to the beginning of the group. For example, the FEW could be calculated as follows: determine how many hops between the first event occurring and the last event occurring (for example a maximum of four hops required to traverse the map); determine how many hops between the first event and the selected event (for example three hops); and a reduced FEW is applied the more hops that are required to get to the selected event (for example the FEW might be dropped by three quarters).

The FEW is reduced because those events earlier in the cycle are more likely to be causative; those that are later are more likely to be symptomatic. Furthermore, those events later in the cycle are likely to arrive after a problem is already known about and being responded to (that is the operator has already starting working on the issue due to the first few events in the speculative group).

Referring to FIG. 4B, in another embodiment, step 360B comprises step 360AB. Step 360AB comprises logical process steps 360AB2 and 360AB4.

Step 360AB2 comprises determining the number of occurrences of a similar historical group.

Step 360AB4 comprises determining a FEW value whereby the FEW value is proportional to how many occurrences of the similar historical group have the same associated further event action.

The FEW is changed as follows, in one example: instead of every event in the flurry receiving a weight of one, each event receives a FEW between zero and one depending on what percentage of previous occurrences have received a ticket. For example, the FEW could be calculated as follows: determine how many occurrences have occurred (for example ten); determine how many occurrences had previously received a ticket (for example five); and apply a reduced FEW to these events (for example the weight might be dropped by a half).

The reason for reducing the weight is that those flurries which do not always lead to a ticket should have a lower FEW than those that always lead to a ticket.

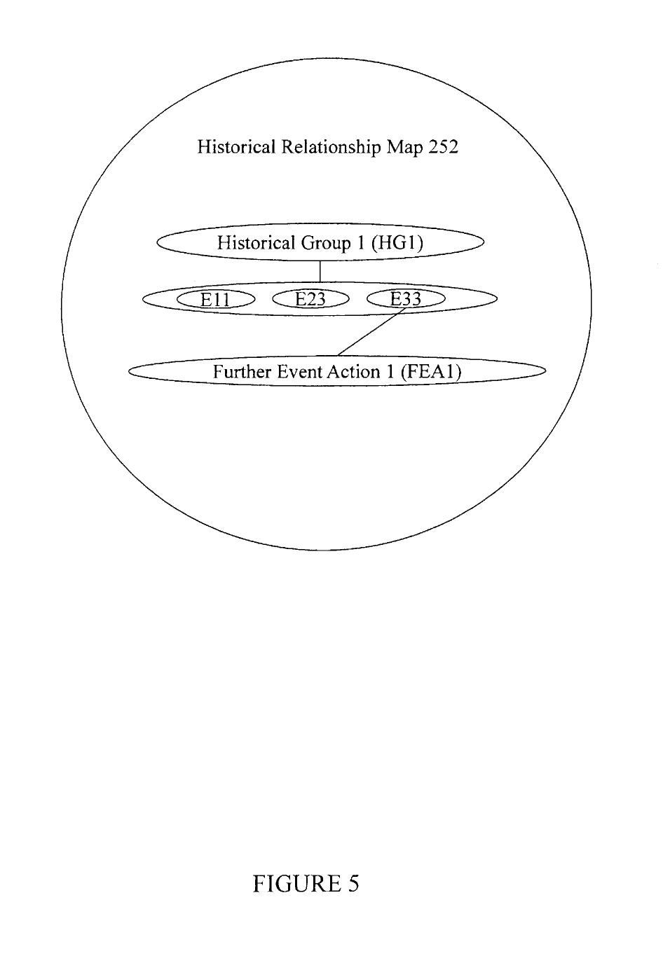

Referring to FIG. 5, an example of an historical group of events is shown. Event E33 is associated with a further event action FEA1. Together events E11, E23 and E33 have been associated by association rule miner 204 as a group of events that are more than coincidentally associated with further event action FEA1, and therefore, historical group 1 (HG1) is defined within historical relationship map 252.

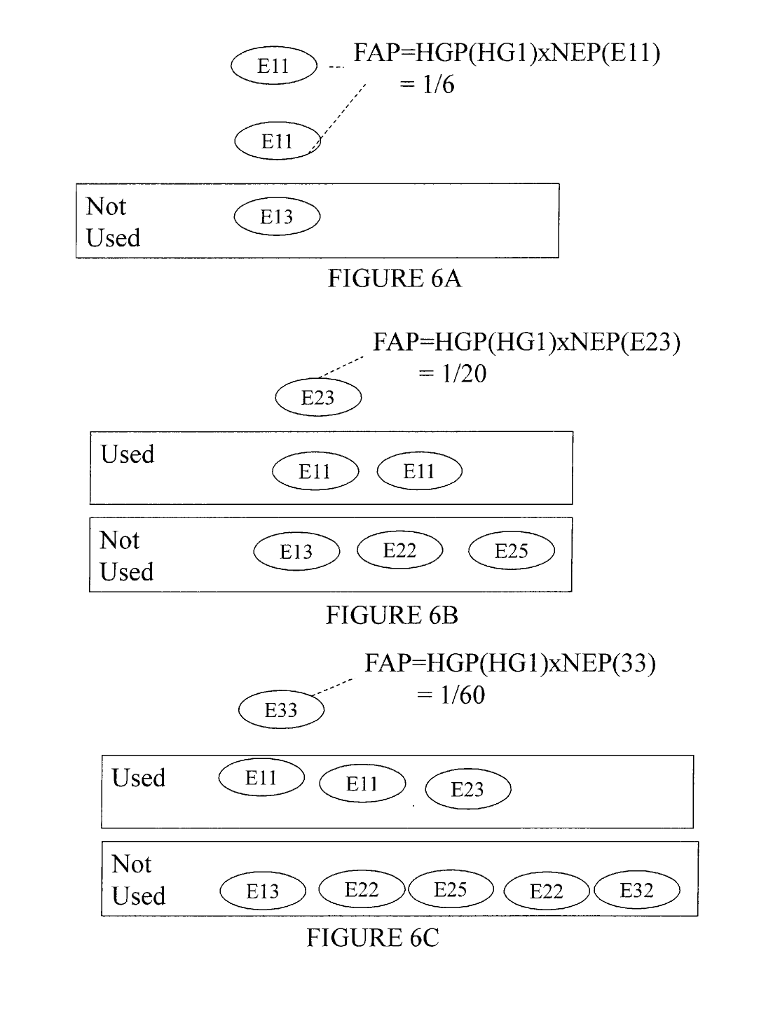

Referring to FIGS. 6A, 6B, and 6C, state diagrams are described for new events being received at different stages according to one embodiment.

Referring to FIG. 6A, three new events are recorded: two event E11s and one event E13. The two E11 events are determined by association rule miner 204 as having similarities similar to historical group HG1 that has previously led to a further event action 1 (FEA1). Therefore, both E11 events are respectively assigned a further event action probability (FAP) by multiplying the probability of the associated historical group leading to an historical further event action (HGP(HG1)) by the probability of the new event being in the associated historical group (NEP(E11)).

The following values for the further event action probability (FAP) are illustrative only. The probability of a further event action (FAP) being associated with the new event is the probability of the associated historical group leading to an historical further event action (HGP) multiplied by the probability of the new event being in the associated historical group (NEP). The probability of an historical grouping leading to an associated historical further event action (HGP) can be approximated as the number of further event actions associated with the historical group (say 500) and the total number of occurrences of the historical group (say 1000) leading to an HGP of 500/1000 or 1/2. Of 3000 example events of type E11, say 1000 are associations with the 1000 HG1 determinations leading to a NEP of 1000/3000 or 1/3. Therefore, FAP is, e.g., HGP(HG1)×NEP(E11)=1/2×1/3=1/6.

Referring to FIG. 6B, three more new events are recorded: E23, E22 and E25. E23 is identified as part of HG1 by association rule miner 204 and assigned a further event action probability (FAP) by multiplying the probability of the associated historical group leading to an historical further event action (HGP(HG1)) by the probability of the new event being in the associated historical group (NEP(E23)). The two remaining events are not identified as part of an historical event group. For 10,000 E23 events NEP(E23)=1000/10000=1/10 and FAP=1/10×1/2=1/20.

Referring to FIG. 6C, three more new events are recorded: E33, E22 and E32. E33 is identified as part of HG1 by association rule miner 204 and is assigned a further event action probability (FAP) by multiplying the probability of the associated historical group leading to an historical further event action (HGP(HG1)) by the probability of the new event being in the associated historical group (NEP(E33)). The remaining events are not identified as part of a group. For 30000 E33 events the NEP(E33) is 1000/30000=1/30 and FAP=1/30×1/3=1/60.

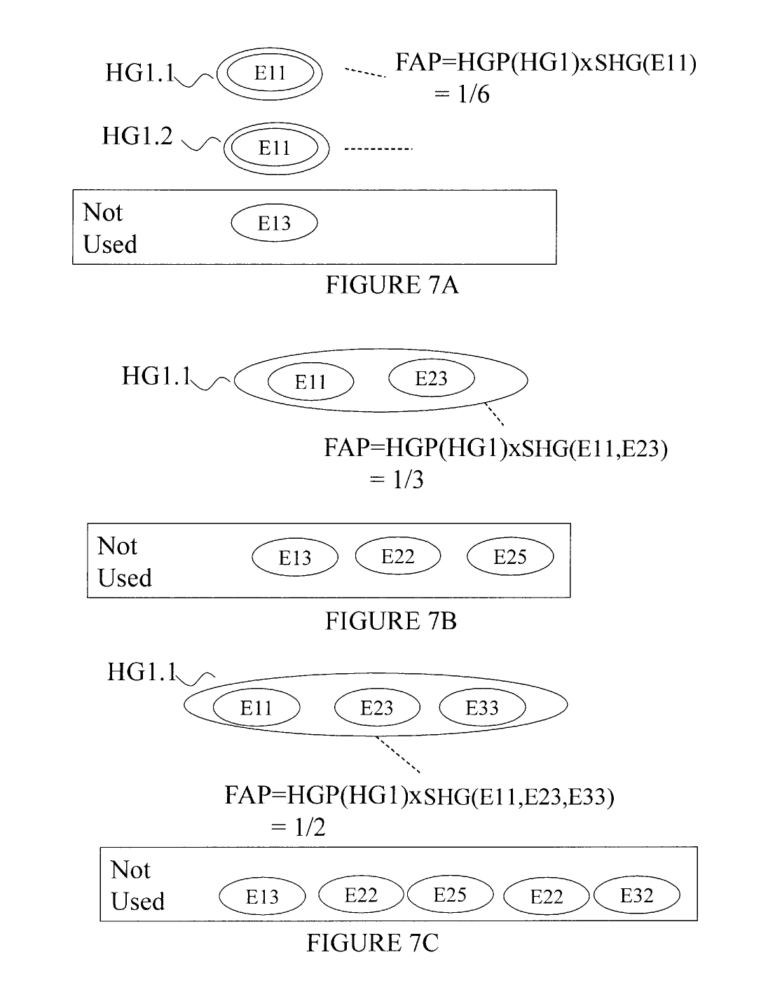

FIGS. 7A, 7B, and 7C are state diagrams of different probabilities of speculative groups as further events are received at each stage for an example of an alternative embodiment.

Referring to FIG. 7A, three new events are recorded: two event E11s and event E13. All E11 events, both historical and new, are the same type of event having the characteristic of E11. Two speculative groups for one historical group type are created from two new E11 events because each may lead to a group of new events (that may further lead to a further event action) but the speculative groups may not necessarily lead to its historical group type. The two E11 events are determined by association rule miner 204 as having similarities similar to historical group HG1 that has previously led to a further event action 1 (FEA1). Both E11 events are respectively associated with speculative groups HG1.1 and HG1.2 with an expectation that further events may lead to a further event action or actions (FEA1). Since E11 is one of the three events that make up HG1 then the probability of the speculative group leading to the historical group (SHG) is determined by action probability classifier 210 as one of three or 33%. Using the probability of the associated historical group leading to an historical further event action (HGP) from the previous example, HGP=1/2. Therefore, FAP=HGP(HG1)×SHG(E11)=1/2×1/3=1/6

Referring to FIG. 7B, three more new events are recorded: E23, E22 and E25. E23 is identified as part of HG1 by association rule miner 204 and the first speculative group now has two events. Action probability classifier 210 determines that with two events out of three then the probability of the speculative group leading to the historical group (SHG) is determined as two thirds or 66% probability. The two remaining events are not identified as part of a group. Therefore FAP=HGP(HG1)×SHG(E11,E23)=1/2×2/3=1/3.

Referring to FIG. 7C, three more new events are recorded: E33, E22 and E32. E33 is identified as part of HG1 by association rule miner 204 and the first speculative group HG1.1 now has three events, whereas HG1.2 only has one event. Then the probability of the speculative group leading to the historical group (SHG) is determined by action probability classifier 210 with three events out of three as one or 100% probability. The remaining events are not identified as part of a group. Therefore, FAP=HGP(HG1)×SHG(E11, E23, E33)=1/2×1=1/2.

As described herein, in one aspect of the invention, there is provided a network management system comprising: an index of historical events, some of which are associated with at least one historical group type and including for the at least one historical group type, the probability that an historical group of that type will lead to a further event action and further including, for each historical event type, the probability that an historical event of that type will be in the at least one historical group; an event classifier for determining, from the index, a historical group type associated with a new event; an action probability classifier for determining the probability of a further event action occurring due to the new event based on the probability of the associated historical group leading to an historical further event action and the probability of the new event being in the associated historical group; and an event tagger for assigning the probability of the further event action to the new event.

One embodiment is an event management system. An event management system is a type of network management system, and the terms are used interchangeably in the description.

In another aspect of the invention, there is provided a method for a network management system comprising: receiving an index of historical events, some of the historical events are associated with at least one historical group type and the index including for the at least one historical group type, the probability that a group of events of that type will lead to a further event action and further including, for each historical event type, the probability that an event of that type will be in the at least one historical group; receiving a new event; determining, from the index, an historical group type associated with the new event; determining the probability of a further event action occurring due to the new event based on the probability of the associated historical group leading to a historical further event action and the probability of the new event being in the associated historical group; and assigning, to the new event, the probability of the further event action occurring due to the new event.

According to yet another aspect of the invention, there is provided a computer program product for a network management system, the computer program product comprising a computer readable storage medium having program instructions embodied therewith, the program instructions executable by a processor to cause the processor to: provide a plurality of historical events from the network management system; identifying an historical group type of related historical events within the plurality of historical events that can lead to a further event action and identifying a further event action probability for a group of new events of the historical group type; create an index of historical group types and respective probabilities of leading to further event actions; and create an index of historical event types and respective probabilities of being in an historical group type.

One or more embodiments rely on analyzing a body or archive of events, which have been associated with remediations. In general, when an event is ticketed (also known as a further event action), the event is enriched with the ticket number or other indication of the ticket created by the event management system. One or more embodiments then analyze the body of events that have been so enriched and for a given newly received event, determines the increased chance that the newly received event will eventually receive a manually assigned ticket or be linked with an event that does. One or more embodiments are capable of determining that there is an increased chance of ticketing for a given event, even in the following circumstances: similar given events were not ticketed in the past, so long as at least one other event in the flurry was ticketed; the operator applying tickets does not know the relationship between a given event and a ticketed event; and/or the given event can have the increased chance applied, even before another event in the latest flurry is ticketed.

One or more aspects can also be described by the following: receiving a plurality of events; associating an indicator of further event action (for example a ticket) for at least one event; learning about events that are related to one another on historic data; receiving at least one more event; determining the increased chance that the newly received event will be part of a linked group responsive to previous event indications where at least one of the linked group will receive the same further event action as opposed to one selected randomly; and provide an indicator of the aforementioned increased chance of action, such as a lift score.

One or more embodiments show how to build a system that, upon receiving possibly the first instance of an event, can attribute a likelihood that this event will be a pre-cursor or part of a larger set of events where one of the overall set of events will receive further attention. The event receiving the further attention will not necessarily be this first event.

One or more embodiments assign an increased chance or increased propensity to each event as the event based on connected other events and by learning statistical models on historic behavior.

Further embodiments of the invention are now described. It will be clear to one of ordinary skill in the art that all or part of the logical process steps of one or more embodiments may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of one or more embodiments may be alternatively embodied in logic apparatus comprising logic elements to perform the steps of the method, and that such logic elements may comprise components such as logic gates in, for example, a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, one or more aspects of the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of one or more embodiments may alternatively be embodied fully or partially in a parallel computing system comprising two or more processors for executing parallel software.

One or more aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be clear to one skilled in the art that many improvements and modifications can be made to the foregoing exemplary embodiment without departing from the scope of the present invention.

What is claimed is:

1. A method comprising:
receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group;
receiving a new event;
determining, from the index, an historical group type associated with the new event;
determining a probability of a further event action occurring due to the new event based on a probability of an associated historical group leading to an historical further event action and a probability of the new event being in the associated historical group; and
assigning, to the new event, the probability of the further event action occurring due to the new event.

2. The method according to claim 1, wherein an association between the new event and the associated historical group is a new association.

3. The method according to claim 1, wherein an association between the new event and the associated historical group is based on a previous association of a previous new event to that associated historical group, and wherein the determining the probability of a further event action being associated with the new event is further based on a probability of the new event and the previous new event being in the associated historical group together.

4. The method according to claim 1, wherein the index includes a further event weighting for the at least one historical group, and wherein the method further comprises assigning the further event weighting to the new event.

5. The method according to claim 4, further comprising adapting a further event weighting proportional to a position of the new event in the historical group type.

6. The method according to claim 1, further comprising:
providing a plurality of historical events from the network management system;
identifying an historical group type of related historical events within the plurality of historical events that can lead to a further event action and identifying a further event action probability for a group of new events of the historical group type;
creating an index of historical group types and respective probabilities of leading to further event actions; and
creating an index of historical event types and respective probabilities of being in an historical group type.

7. A computer program product comprising:
a computer readable storage medium readable by a processing circuit and storing instructions for execution by the processing circuit for performing a method comprising:
receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group;
receiving a new event;
determining, from the index, an historical group type associated with the new event;
determining a probability of a further event action occurring due to the new event based on a probability of an associated historical group leading to an historical further event action and a probability of the new event being in the associated historical group; and
assigning, to the new event, the probability of the further event action occurring due to the new event.

8. The computer program product according to claim 7, wherein an association between the new event and the associated historical group is a new association.

9. The computer program product according to claim 7, wherein an association between the new event and the associated historical group is based on a previous association of a previous new event to that associated historical group, and wherein the determining the probability of a further event action being associated with the new event is further based on a probability of the new event and the previous new event being in the associated historical group together.

10. The computer program product according to claim 7, wherein the index includes a further event weighting for the at least one historical group, and wherein the method further comprises assigning the further event weighting to the new event.

11. The computer program product according to claim 10, wherein the method further comprises adapting a further event weighting proportional to a position of the new event in the historical group type.

12. The computer program product according to claim 7, wherein the method further comprises:
providing a plurality of historical events from the network management system;
identifying an historical group type of related historical events within the plurality of historical events that can lead to a further event action and identifying a further event action probability for a group of new events of the historical group type;
creating an index of historical group types and respective probabilities of leading to further event actions; and
creating an index of historical event types and respective probabilities of being in an historical group type.

13. A network management system comprising:
a memory; and
a processor in communications with the memory, wherein the network management system is configured to perform a method, said method comprising:
receiving an index of historical events, some of the historical events being associated with at least one historical group type and the index including, for the at least one historical group type, a probability that a group of events of that historical group type will lead to a further event action, and further including, for each historical event type, a probability that an event of that historical group type will be in at least one historical group;
receiving a new event;
determining, from the index, an historical group type associated with the new event;
determining a probability of a further event action occurring due to the new event based on a probability of an associated historical group leading to an historical further event action and a probability of the new event being in the associated historical group; and
assigning, to the new event, the probability of the further event action occurring due to the new event.

14. The network management system according to claim 13, wherein an association between the new event and the associated historical group is a new association.

15. The network management system according to claim 13, wherein an association between the new event and the associated historical group is based on a previous association of a previous new event to that associated historical group, and wherein the determining the probability of a further event action being associated with the new event is further based on a probability of the new event and the previous new event being in the associated historical group together.

16. The network management system according to claim 13, wherein the index includes a further event weighting for the at least one historical group, and wherein the method further comprises assigning the further event weighting to the new event.

17. The network management system according to claim 16, wherein the method further comprises adapting a further event weighting proportional to a position of the new event in the historical group type.

18. The network management system according to claim 13, wherein the method further comprises:
providing a plurality of historical events from the network management system;
identifying an historical group type of related historical events within the plurality of historical events that can lead to a further event action and identifying a further event action probability for a group of new events of the historical group type;
creating an index of historical group types and respective probabilities of leading to further event actions; and
creating an index of historical event types and respective probabilities of being in an historical group type.
